(19) United States
(12) Patent Application Publication
(10) Pub. No.: US 2008/0041180 A1
(43) Pub. Date: Feb. 21, 2008

(54) Shift lever system

(75) Inventor: Eunsoo Cho, Hwaseong-city (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/591,748

(22) Filed: Nov. 1, 2006

(30) Foreign Application Priority Data
Aug. 17, 2006 (KR) 10-2006-0077876

(51) Int. Cl. G05G 9/00

(52) U.S. Cl. 74/473.1

(57) ABSTRACT

A shift lever system of a vehicle is provided comprising (a) a shift lever movable between a plurality of predetermined positions corresponding to different shift positions, (b) an engaging lever comprising a pin and connected to the shift lever so as to integrally move with the shift lever, and (c) a sensor module connected to the shift lever to detect predetermined positions of the shift lever, wherein the pin is in cooperation with sensor module such that the sensor module can detect the movement of the shift lever.

### CROSS-REFERENCE TO RELATED APPLICATION

This application claims priority to and the benefit of Korean Patent Application No. 10-2006-0077876 filed in the Korean Intellectual Property Office on Aug. 17, 2006, the entire contents of which are incorporated herein by reference.

### BACKGROUND OF THE INVENTION

### (a) Field of the Invention

The present invention relates to a shift lever system. More particularly, the present invention relates to a shift lever system including at least one sensor.

### (b) Background

Conventional shift lever systems for an automatic transmission of a motor vehicle transmit a shift signal operated by a driver to a transmission control unit or an actuator.

In such conventional shift lever systems, a shift lever is pivotably hinged to the shift lever system. A magnet bracket is connected to the hinge. A magnet is disposed on the magnet bracket. A sensor is located in a printed circuit board (PCB). The sensor is placed near a position where the shift lever rotates. The sensor detects the rotation of the magnet bracket by detecting a change in magnetic flux density that occurs when the magnet rotates.

However, the sensor can detect only a rotation movement of the shift lever because the shift lever is pivotably hinged. As a result, the conventional shift lever system cannot be applied to various kinds of vehicles. In addition, because a position of the shift lever is detected by only one kind of sensor, precision and degree of freedom during design are reduced.

Thus, there is a need for a new shift lever system with both applicability to a wider range of vehicles and enhanced precision and degree of freedom for system design.

The above information disclosed in this Background of the Invention section is only for enhancement of understanding of the background of the invention and should not be taken as an acknowledgement or any form of suggestion that this information forms the prior art that is already known to a person of ordinary skill in the art.

### SUMMARY OF THE INVENTION

In one aspect, a shift lever system of a vehicle is provided comprising (a) a shift lever movable between a plurality of predetermined positions corresponding to different shift positions, (b) an engaging lever comprising a pin and connected to the shift lever so as to integrally move with the shift lever, and (c) a sensor module connected to the shift lever to detect predetermined positions of the shift lever, wherein the pin is in cooperation with sensor module such that the sensor module can detect the movement of the shift lever.

In a preferred embodiment, the sensor module may comprise (a) a magnet bracket having at least one magnet and a slot thereon, wherein the slot is connected to the pin such that the magnet bracket can move corresponding to the movement of the pin, (b) a guide connected to the magnet bracket, which is configured to guide the magnet bracket, and (c) a sensor unit having at least one sensor mounted therein to detect a change in the magnetic flux density of the magnet corresponding to the movement of the magnet bracket.

In another aspect, a shift lever system of a vehicle is provided comprising: (a) a shift lever movable between a plurality of predetermined positions corresponding to different shift positions; (b) an engaging lever comprising a pin and connected to the shift lever so as to integrally move with the shift lever; (c) an indicator indicating a position of the shift lever; (d) a sensor module connected to the shift lever to detect predetermined positions of the shift lever; and (e) a base bracket to which the shift lever, the engaging lever, the indicator, and the sensor module are located, wherein the sensor module comprises: (i) a magnet bracket having at least one magnet and a slot thereon, wherein the slot is connected to the pin such that the magnet bracket can move corresponding to the movement of the pin; (ii) a guide connected to the magnet bracket, which is configured to guide the magnet bracket; (iii) a sensor unit having at least one sensor therein to detect a change in the magnetic flux density of the magnet corresponding to the movement of the magnet bracket; (iv) a printed circuit board (PCB) to which the sensor unit is located; and (v) a housing to which the magnet bracket, the guide, the sensor unit, and the PCB are located.

In yet another aspect, motor vehicles are provided that comprise a described shift lever system.

It is understood that the term “vehicle” or other similar term as used herein is inclusive of motor vehicles in general such as passenger automobiles, buses, trucks, various commercial vehicles, and the like.

Other aspects of the invention are discussed infra.

### BRIEF DESCRIPTION OF THE DRAWINGS

FIG. 1 is an exploded perspective view showing a shift lever system according to an exemplary embodiment of the present invention.

FIG. 2 shows a sensor module according to an exemplary embodiment of the present invention.

FIG. 3 is a cross-sectional view along the line II-II of FIG. 2.

FIG. 4 shows an operation of a sensor module according to an exemplary embodiment of the present invention.

Reference numerals used herein refer to the following elements.

101: sensor module

103: engaging lever

105: N stopper

107: shift lever

109: knob

111: indicator

113: damper

115: base bracket

201: magnet bracket

203: guide

205: PCB

207: housing

301: first magnet

303: second magnet

305: first sensor

307: second sensor

### DETAILED DESCRIPTION

As discussed above, in one aspect, the present invention provides a shift lever system of a vehicle comprising (a) a shift lever movable between a plurality of predetermined positions corresponding to different shift positions, (b) an engaging lever comprising a pin and connected to the shift lever so as to integrally move with the shift lever, and (c) a sensor module connected to the shift lever to detect predetermined positions of the shift lever, wherein the pin is in cooperation with sensor module such that the sensor module can detect the movement of the shift lever.

Preferably, the sensor module may comprise (a) a magnet bracket having at least one magnet and a slot thereon, wherein the slot is connected to the pin such that the magnet bracket can move corresponding to the movement of the pin, (b) a guide connected to the magnet bracket, which is configured to guide the magnet bracket, and (c) a sensor unit having at least one sensor mounted therein to detect a change in the magnetic flux density of the magnet corresponding to the movement of the magnet bracket.

In a preferred embodiment of the present invention, depending upon the configuration of the guide, the magnet bracket can move along a straight line or a curved line.

In another preferred embodiment, the magnet bracket may comprise a plurality of magnets. Preferably, it may have a first magnet located to an upper portion of the slot and a second magnet located to a lower portion of the slot. Also preferably, it may further have an additional magnet(s).

Likewise, a preferred sensor unit of the present invention may comprise a first sensor detecting a position of the first magnet and a second sensor detecting a position of the second magnet. Another preferred sensor unit may further have an additional sensor(s).

Although there is no limitation on the kind of sensor, a suitable sensor can be designed as a hall sensor or a linear hall integrated circuit (IC) sensor. In a preferred embodiment employing two sensors, the first sensor can be a hall sensor and/or the second sensor can be a linear hall IC sensor.

In a further preferred embodiment, the shift lever system of the present invention may further comprise an indicator that indicates a position of the shift lever.

The shift lever, the engaging lever and the sensor module may preferably be formed in a base bracket. Also, the sensor unit may suitably be formed in a printed circuit board. In addition, the magnet bracket, the guide, and the sensor unit may preferably be formed in a housing.

In another aspect, a shift lever system of a vehicle is provided comprising: (a) a shift lever movable between a plurality of predetermined positions corresponding to different shift positions; (b) an engaging lever comprising a pin and connected to the shift lever so as to integrally move with the shift lever; (c) an indicator indicating a position of the shift lever; (d) a sensor module connected to the shift lever to detect predetermined positions of the shift lever; and (e) a base bracket to which the shift lever, the engaging lever, the indicator, and the sensor module are located, wherein the sensor module comprises: (i) a magnet bracket having at least one magnet and a slot thereon, wherein the slot is connected to the pin such that the magnet bracket can move corresponding to the movement of the pin; (ii) a guide connected to the magnet bracket, which is configured to guide the magnet bracket; (iii) a sensor unit having at least one sensor therein to detect a change in the magnetic flux density of the magnet corresponding to the movement of the magnet bracket; (iv) a printed circuit board (PCB) to which the sensor unit is located; and (v) a housing to which the magnet bracket, the guide, the sensor unit, and the PCB are located.

In a preferred embodiment, depending upon the configuration of the guide, the magnet bracket can move along a straight line or a curved line.

In another preferred embodiment, the magnet bracket may comprise a plurality of magnets. Preferably, it may have a first magnet located to an upper portion of the slot and a second magnet located to a lower portion of the slot. Also preferably, it may further have an additional magnet(s).

Likewise, a preferred sensor unit of the present invention may comprise a first sensor detecting a position of the first magnet and a second sensor detecting a position of the second magnet. Another preferred sensor unit may further have an additional sensor(s).

Although there is no limitation on the kind of sensor, a suitable sensor can be designed as a hall sensor or a linear hall integrated circuit (IC) sensor. In a preferred embodiment employing two sensors, the first sensor can be a hall sensor and/or the second sensor can be a linear hall IC sensor.

In yet another aspect, the present invention provides motor vehicles that comprise a described shift lever system.

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

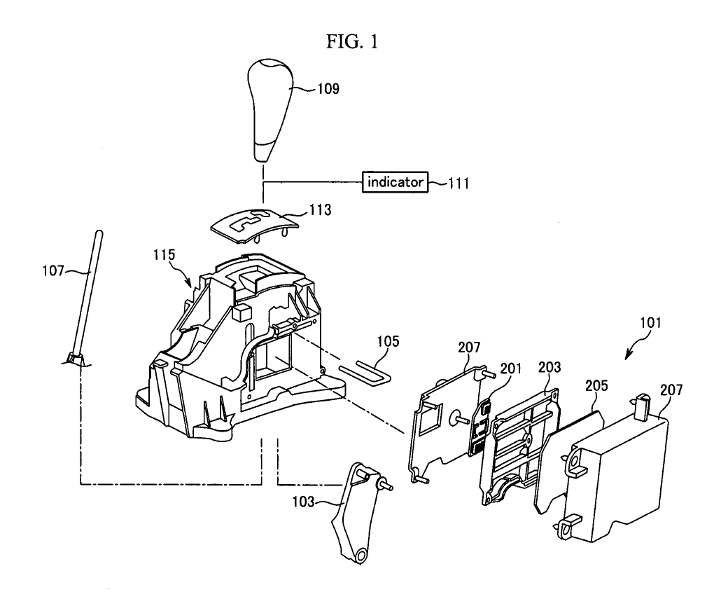

FIG. 1 is an exploded perspective view showing a shift lever system according to an exemplary embodiment of the present invention.

As shown in FIG. 1, in a preferred embodiment of the present invention, the shift lever system may comprises a shift lever 107, an engaging lever 103, an indicator 111, a sensor module 101, and a base bracket 115.

The shift lever 107 is movable between a plurality of predetermined positions corresponding to different shift positions. The engaging lever 103 comprises a pin 211 and is connected to the shift lever 107. The engaging lever 103 can integrally move with the shift lever 107.

The indicator 111 indicates a position of the shift lever 107 to the outside. The sensor module 101 is connected to the shift lever 107 to detect predetermined positions of the shift lever 107.

The shift lever 107, the engaging lever 103, the indicator 111, and the sensor module 101 can be located to the base bracket 115.

Preferably, a knob 109 can be connected to the shift lever 107 through a damper 113 that functions as a noise reducer.

That is, the shift lever 107 is connected to the sensor module 101 through the engaging lever 103.

Because the base bracket 115, the shift lever 107, the indicator 111, and the engaging lever 103 are obvious to a person of an ordinary skill in the art, detailed descriptions thereof are omitted herein.

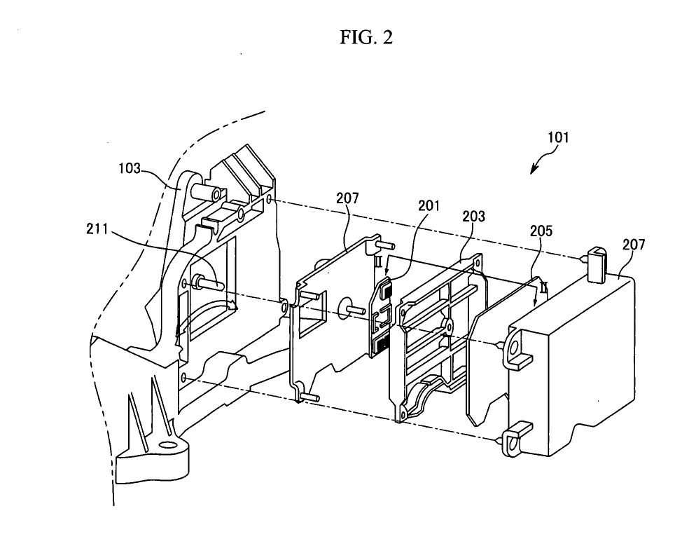

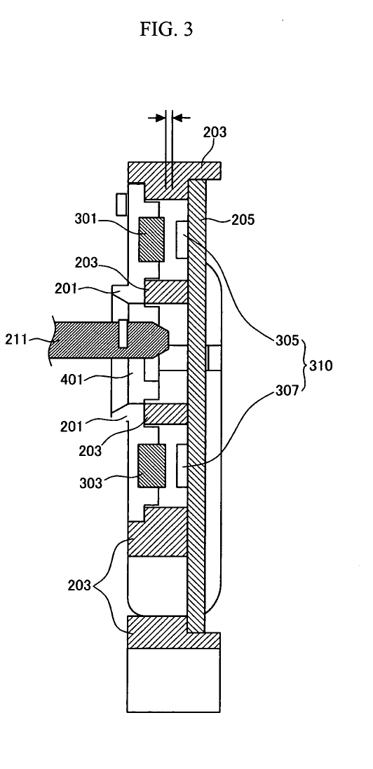

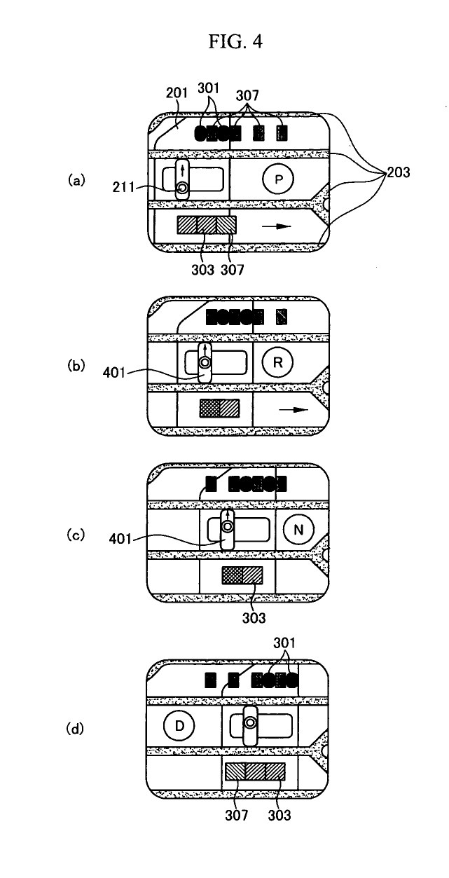

FIG. 2 shows a sensor module according to an exemplary embodiment of the present invention, FIG. 3 is a cross-sectional view along a line II-II of FIG. 2, and FIG. 4 shows an operation of a sensor module according to an exemplary embodiment of the present invention.

Referring to FIG. 2 to FIG. 4, the sensor module 101 may include a magnet bracket 201, a guide 203, a sensor unit 310, a printed circuit board (PCB) 205, and a housing 207.

Preferably, the magnet bracket 201 may include two magnets 301 and 303 generating a magnetic force. A slot 401 is formed to the magnet bracket 201 to which a pin 211 is connected such that the magnet bracket 201 can move corresponding to a movement of the pin 211.

The guide 203 guides the magnet bracket 201.

The sensor unit 310 is provided to detect a change in magnetic flux density of the magnets 301 and 303 corresponding to the movement of the magnet bracket 201. The sensor unit 310 includes at least one sensor. The sensor unit 310 can be located to the PCB 205.

The magnet bracket 201, the guide 203, the sensor unit 310, and the PCB 205 can be located to the housing 207. That is, as shown in FIG. 2, the sensor module 101 is mounted outside of the base bracket 115.

If the shift lever 107 moves, the engaging lever 103 moves (referring to an arrow in FIG. 2) and the pin 211 connected to the engaging lever 103 moves accordingly.

The pin 211 is secured to the engaging lever 103 and is connected to the magnet bracket 201 through the housing 207. Therefore, if the shift lever 107 moves, the magnet bracket 201 moves along the guide 203.

The magnet bracket 201 can move along a straight line or a curved line. Referring to FIG. 4, in a preferred embodiment of the present invention, the pin 211 is movably connected with the slot 401. Although the pin 211 moves along an arc shape, the magnet bracket 201 moves along a straight line.

More particularly, FIG. 4 shows the movements of the magnet bracket 201 corresponding to different shift positions. For example, FIG. 4(a) shows that the shift lever 107 is located in parking P range. FIGS. 4(b), (c) and (d) show reverse R range, neutral N range, and driving D range, respectively.

As shown in those FIGS., if the shift lever 107 moves, the pin 211 will push the magnet bracket 201. In turn, the magnet bracket 201 will move in the right direction and the pin 211 will move upwardly. Therefore, the magnet bracket 201 can move along the straight line.

Alternatively, if the pin 211 is arranged such that the pin 211 does not move in the slot 401 and the guide 203 is formed as a curved line shape, the magnet bracket 201 can move along the curved line.

Therefore, the present invention improves the degree of freedom and simultaneously reduces the system tolerance.

A preferred magnet bracket may have a plurality of magnets. For example, as shown in FIG. 4, magnet bracket 201 may include a first magnet 301 and a second magnet 303. The first magnet 301 can be located to an upper portion of the slot 401 and the second magnet 303 can be located to a lower portion of the slot 401.

The sensor unit 310 may include a first sensor 305 and a second sensor 307. The first sensor 305 can detect a position of the first magnet 301 and the second sensor 307 detect a position of the second magnet 303.

In another preferred embodiment, additional sensors may be employed to attain more delicate detection.

The first sensor 305 may be designed as a hall sensor. The second sensor 307 may be designed as a linear hall integrated circuit (IC) sensor.

As shown above, the position of the shift lever can be more precisely detected and the manufacturing tolerance can be more easily reduced. In addition, the shift lever system can be applied to various kinds of vehicles and a degree of freedom during design can be improved.

While this invention has been described in connection with preferred embodiments thereof, it will be appreciated by those skilled in the art that changes may be made in these embodiments without departing from the principles and spirit of the invention, the scope of which is defined in the appended claims and their equivalents.

1. A shift lever system of a vehicle comprising:
(a) a shift lever movable between a plurality of predetermined positions corresponding to different shift positions;
(b) an engaging lever comprising a pin and connected to the shift lever so as to integrally move with the shift lever;
(c) an indicator indicating a position of the shift lever;
(d) a sensor module connected to the shift lever to detect predetermined positions of the shift lever; and
(e) a base bracket to which the shift lever, the engaging lever, the indicator, and the sensor module are located, wherein the sensor module comprises:
(i) a magnet bracket having at least one magnet and a slot thereon, wherein the slot is connected to the pin such that the magnet bracket can move corresponding to the movement of the pin;
(ii) a guide connected to the magnet bracket, which is configured to guide the magnet bracket;
(iii) a sensor unit having at least one sensor therein to detect a change in the magnetic flux density of the magnet corresponding to the movement of the magnet bracket;
(iv) a printed circuit board (PCB) to which the sensor unit is located; and
(v) a housing to which the magnet bracket, the guide, the sensor unit, and the PCB are located.

2. The system of claim 1, wherein the magnet bracket moves along a straight line or a curved line.

3. The system of claim 1, wherein the magnet bracket comprises a first magnet located to an upper portion of the slot and a second magnet located to a lower portion of the slot.

4. The system of claim 3, wherein the sensor unit comprises a first sensor detecting a position of the first magnet and a second sensor detecting a position of the second magnet.

5. The system of claim 4, wherein the first sensor comprises a hall sensor.

6. The system of claim 4, wherein the second sensor comprises a linear hall integrated circuit (IC) sensor.

7. A shift lever system of a vehicle comprising:
(a) a shift lever movable between a plurality of predetermined positions corresponding to different shift positions;
(b) an engaging lever comprising a pin and connected to the shift lever so as to integrally move with the shift lever; and
(c) a sensor module connected to the shift lever to detect predetermined positions of the shift lever, wherein the pin is in cooperation with sensor module such that the sensor module can detect the movement of the shift lever.

8. The system of claim 7, wherein the sensor module comprises:
(a) a magnet bracket having at least one magnet and a slot thereon, wherein the slot is connected to the pin such that the magnet bracket can move corresponding to the movement of the pin;
(b) a guide connected to the magnet bracket, which is configured to guide the magnet bracket; and
(c) a sensor unit having at least one sensor mounted therein to detect a change in the magnetic flux density of the magnet corresponding to the movement of the magnet bracket.

9. The system of claim 7, wherein the magnet bracket moves along a straight line or a curved line.

10. The system of claim 7, wherein the magnet bracket comprises a first magnet located to an upper portion of the slot and a second magnet located to a lower portion of the slot.

11. The system of claim 10, wherein the sensor unit comprises a first sensor detecting a position of the first magnet and a second sensor detecting a position of the second magnet.

12. The system of claim 11, wherein the first sensor comprises a hall sensor.

13. The system of claim 1 1, wherein the second sensor comprises a linear hall integrated circuit (IC) sensor.

14. The system of claim 7, further comprising an indicator that indicates a position of the shift lever.

15. The system of claim 7, wherein the shift lever, the engaging lever and the sensor module are formed in a base bracket.

16. The system of claim 7, wherein the sensor unit is formed in a printed circuit board (PCB).

17. The system of claim 7, wherein the magnet bracket, the guide, and the sensor unit are formed in a housing.

18. A vehicle comprising the shift lever system of claim 7.
